(19) United States
(12) Patent Application Publication
(10) Pub. No.: US 2021/0215176 A1
(43) Pub. Date: Jul. 15, 2021

(54) MOUNTING SYSTEM WITH FORCE INDICATOR

(71) Applicant: Hall Labs LLC, Provo, UT (US)

(72) Inventors: David R. Hall, Provo, UT (US); Jerome Miles, Spanish Fork, UT (US); Scott Skousen, Lehi, UT (US)

(73) Assignee: Hall Labs LLC, Provo, UT (US)

(21) Appl. No.: 16/741,685

(22) Filed: Jan. 13, 2020

(51) Int. Cl. F16B 1/00; F16B 29/00; F16B 43/00; F16M 13/02

(52) U.S. Cl. CPC F16B 1/0071; F16M 13/027; F16B 43/00; F16B 29/00

(57) ABSTRACT

A mounting system using a force indicator is disclosed. A screw is used to mount a bracket to a structure. While the screw is being threaded into the structure, the force indicator deforms to provides a visual indication when the screw is tight enough to secure the bracket to the structure without damaging the structure or mounting components. Additionally, a washer may be used with the mounting system. The force indicator can be cylinder shaped with a hole for the screw to pass through. The force indicator can extrude radially as it deforms in order to provide the visual indication.

### TECHNICAL FIELD

This invention relates to mounting systems, and more specifically to systems with threaded fasteners.

### BACKGROUND

Threaded fasteners (interchangeably “bolt”, “bolts”, “screw”, and “screws”), in conjunction with a mating threaded piece of material, are one method used to fasten a portion of material to another. One important part of that fastening is making sure the screw is tightened so the fastened connection is strong enough, but not overtightened, which could break the material, screw, or threads. For example, a lag screw might be used to attach a bracket to a wooden ceiling joist overhead. If the screw is over tightened, the screw head could come off or the screw could pull out of the wood, thus causing the bracket to fall and potentially injuring someone or causing damage to something in the nearby area.

A common method for achieving a desired screw tightness uses a torque wrench to tighten the screw into the mating material. The idea being that a specific torque, in combination with the surface area of the threads in contact and the friction/slip characteristics of the screw threads and matting threads, a desired clamping force may be achieved. In practice, this method can have a significant margin of error due to, among other things, irregularities in thread manufacture and in materials.

Another method to limit the clamping force is through the use of a power drill that has a clutch designed to disengage in an over torqueing event. Generally, the cutout value of the torque can be set through the use of a rotating collar on the drill. The various torque settings on the collar are often associated with whole numbers from 1 to 20 and have torque values that differ between drills and brands. These drills have a particular niche in general construction with cordless and other hand tools.

An alternative to using a torque wrench or drill with a torque cutout is to directly measure the clamping force. Generally, the methods of doing this are more expensive and intensive, making them better suited for laboratory testing and less suited to industry applications. An example of this include placing an electronic sensor between the bolt head and whatever it's threading into.

A recent method for directly measuring the clamping force uses a metal washer with hollow protrusions where the protrusions are made so as to flatten into the washer when a minimum clamping force is applied to the bolt/mating material. In some versions of this, a dye or other colored material fills the hollows. When the protrusions are flattened, the gap between the washer and bolt or mating material disappears and, if there is dye/colored material, the dye/colored material is squeezed out of the hollows across the outside diameter of the washer and can thus provide visual indication that the protrusions have been flattened. These washers are called “direct tension indicators”, are covered by ASTM Standard F959, which defines requirements for direct tension indicators for use with ½″ to 1½″ A325 and A490 structural bolts (as well as size M16 to M36 bolts), and indicate clamping force loads in the 12,000 psi-143,000 psi range (see https://www.astm.org/Standards/F959.htm and https://www.portlandbolt.com/technical/specifications/astm-f959/).

The compression strength of building materials varies widely. The direct tension indicators described above work can well for mounting to structural steel and other metals with compressive strengths over 12,000 psi, but even still, if the metal is too thin, a clamping force of 12,000 psi can compromise the structural integrity. Additionally, many common building materials have compressive strengths that are significantly lower, especially in residential and non-structural applications. For example, the compressive strength of many types of wood and engineered wood products fall between 100 psi and 12,000 psi. Furthermore, when a grain is present, the compressive strength is highly dependent on whether the compression is parallel to, perpendicular to, or at another angle to the grain of the wood. Dry wall often has a compressive strength around 400 psi.

### SUMMARY

In a first aspect, the invention is a system for mounting to a structure using a force indicator, wherein as a screw is driven into a structure to mount a bracket to the structure, the force indicator deforms to provide a visual indication when the screw has achieved a sufficient clamping force to secure the bracket to the structure without overtightening the screw.

In a second aspect, the invention is a method for installing a bracket to a structure. A screw is provided with a screw head. A bracket is also provided. A force indicator is positioned between the screw head and the bracket, the force indicator includes a deformable material. The screw is driven through a force indicator and bracket to secure the bracket to a structure. While driving the screw, the installer watches for a visual indication from the force indicator that the screw has achieved a sufficient clamping force to secure the bracket to the structure. After observing the visual indication from the force indicator that the screw has achieved a sufficient clamping force to secure the bracket to the structure, the installer stops the driving of the screw and thereby avoids overtightening.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is an exploded view of one embodiment of the invention and a supporting structure.

FIG. 2 is a cross section view of the embodiment of the invention depicted in FIG. 1, after installation.

FIG. 3 is a cross section view of the embodiment of the invention depicted in FIG. 1.

FIG. 4 is a view of a portion of one embodiment of the invention.

FIG. 5 is a cross section view of one embodiment of the invention.

FIG. 6 is a cross section view of one embodiment of the invention.

FIG. 7 is a cross section view of one embodiment of the invention.

FIG. 8 is a view of a portion of one embodiment of the invention.

FIG. 9 is a view of a portion of one embodiment of the invention.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “composite” is meant to refer to a physical thing which is a combination of multiple materials. Some materials—such as drywall, particle board, OSB, fiberglass, and carbon fiber—may be considered composite materials from a material science perspective, but from a construction or builder's perspective, and as used herein, such composites materials are grouped in the general category of “material” or “materials”. Thus as used herein, an example of a composite is plastic and particle board being held together by channels, adhesive, or nuts and bolts.

As used herein, “male thread” and “female thread” are meant to refer to threading on materials which mate together. The male threads are on the exterior of a shape—such as a cylinder or cone. The female threads are on the inside of a hole large enough to receive the male threaded portion. Matting threads generally require the male thread to rotate relative to the female thread in a helical direction to mate or unmate.

As used herein, “screw” and “bolt” are meant to refer to a portion of material with male threads. A screw or bolt generally has a shank comprising male threads. Each generally have a head which is configured to receive force or torque from a tool to rotate the screw or bolt relative to the female threads. The head is generally attached to one end of the shank and has a flat or conical surface extending radially from the shank. When a screw or bolt is used for mounting, this surface generally exerts a force onto the mounting system. As used herein, that force is called the “clamping force”. The clamping force is a result of creating tension in the screw or bolt between the male threads and the head. This tension is often referred to as “preload force” or “pretension”. This tension may exist in non-screw or non-bolt systems where there is a member, such as a shaft, which is in tension and contributes to the creation of a clamping force.

As used herein, “mating material”, “mating portion”, or similar terms are meant to refer to a portion of material with female threads.

As used herein, “overtight” and its variants are meant to refer to exceeding a desired clamping force for a bolted or screwed connection. Overtightening can result in compromising the structural integrity of the connection and/or damage to the bolt or screw, the female threads cut into the wood, or other elements that experience load due to the clamping and other forces at the connection. Examples of damage include stripping a screw head, the screw head or shank breaking, stripping the male or female threads, or fracturing or otherwise damaging whatever is being bolted or screwed.

As used herein, “force indicator” is meant to be something which indicates one or more discrete force has been achieved.

As used herein, “washer” is meant to refer to a thin piece of material whose primary purpose is to improve the structural characteristics of a bolted or other connection that is pretensioned and applies a clamping force. Such improvements could include the distribution of the load from a threaded fastener, such as a screw, bolt, nut, or mating material; acting as a spacer; acting as a spring; acting as a locking device; acting as a vibration reducer. As used herein, the properties that make something a force indicator are unrelated to the properties that make something a washer and they are independent and thus considered without regard to the other.

As used herein, “installer side” is meant to refer to the side of something from which a person is working on or viewing materials which said person is working on.

As used herein, “perimeter” refers to the outside edge of something when viewed from an axis perpendicular to a clamping surface of the force indicator described herein.

As used herein, a “safety” color is meant to refer to a color that typically has a high contrast relative to everyday environments. One example of this is safety yellow, which is used in safety vests often worn by construction or other industrial workers, crossing guards, runners, and cyclists to increase their visibility to traffic around them. Safety orange is a common color for road cones and construction signs. Safety yellow and safety orange are also common colors to paint items in industrial environments to make them more noticeable to people working in the area. Some safety colors are neon and make use of florescence or ultraviolet pigments.

As used herein, “glow-in-the-dark” is meant to refer to the property wherein an item has self-illuminating properties in the visible spectrum that can be activated at a desired time. Examples of the glow-in-the-dark property include exposing a phosphorescence material to light, causing it to emit light; removing a barrier between chemicals so the chemicals may begin a reaction which produces visible light; and a mechanoluminescent material which emits light following physical manipulation.

As used herein, “bracket” is meant to refer to an item configured to be mounted to a structure and to support an article. One example is that of a shelf (the article) supported by a bracket wherein the bracket is screwed or bolted to a wall (the structure). Another example is of a bent piece of sheet metal (the bracket) attached to a ceiling (the structure) and supporting a motor for a garage door opener or winch (the article).

As used herein, “hardness” is meant to refer to the pliability of a solid material. “Hard” and its variations are meant to refer to materials with less pliability. “Softer” and its variations are meant to refer to more pliable materials. Any solid could be placed on a range with the most pliable materials on one side and less pliable materials going toward the other. One common way of determining the hardness of a material is by measuring the indentation in the material created by pressing a tool into the material using a predetermined method or procedure. There are many tests that span portions of the overall range of hardnesses solids can have. One such set of tests is named “Shore” and includes Types that encompass the pliability of Polyurethanes, Gels, Rubbers, and Plastics. Different tests—such as Mohs, Brinell, and Rockwell—are used for harder materials like metals. Examples of some Shore scales are Shore 00, Shore A, and Shore D, each of which are assigned a numerical value higher than 0 and lower than 100 with hardness increasing from 0 to 100. Generally speaking, Shore 00 is for softer materials, Shore D is for harder materials, and Shore A overlaps the harder range of Shore 0 and the softer range of Shore D.

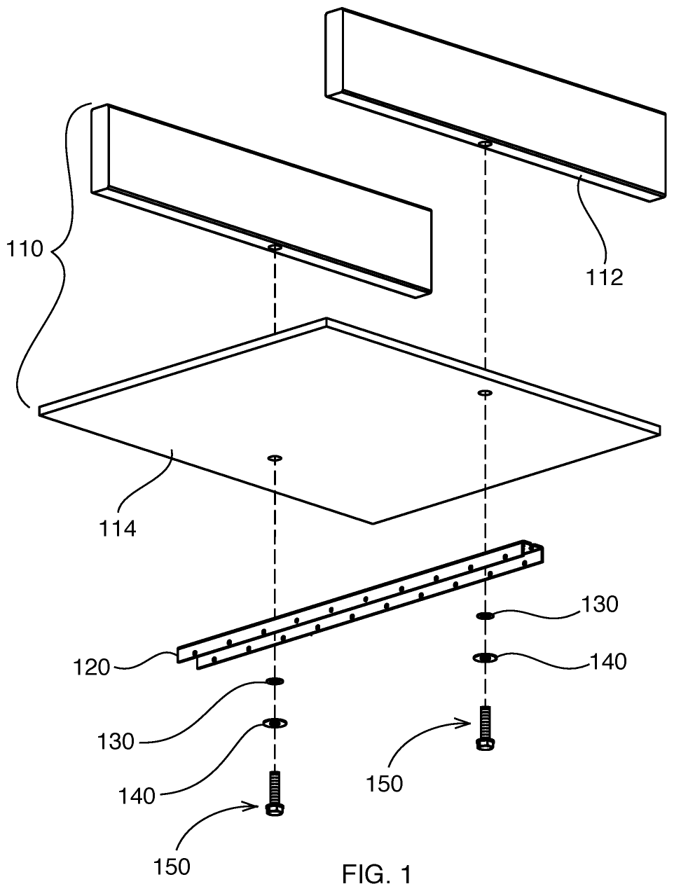

Now referring to FIGS. 1, 2 and 3, one embodiment of the invention is demonstrated. In this embodiment, screw 150 passes through a hole in washer 140, a hole in force indicator 130, and a circular or slot shaped hole in bracket 120. Screw 150 then threads into structure 110. In an alternative embodiment, washer 140 may not be included. In another alternative embodiment, the bracket may be omitted or integrated into the structure.

Screws and washers are commonly available items. Screw 150 and washer 140 are selected to meet the needs of an installer to support the loading inherent to the application. More preferably, screw 150 and washer 140 are selected from a catalog of preexisting, mass-produced stock.

Screw 150 includes head 152 and shank 154—“shank” may be used synonymously with “shaft”.

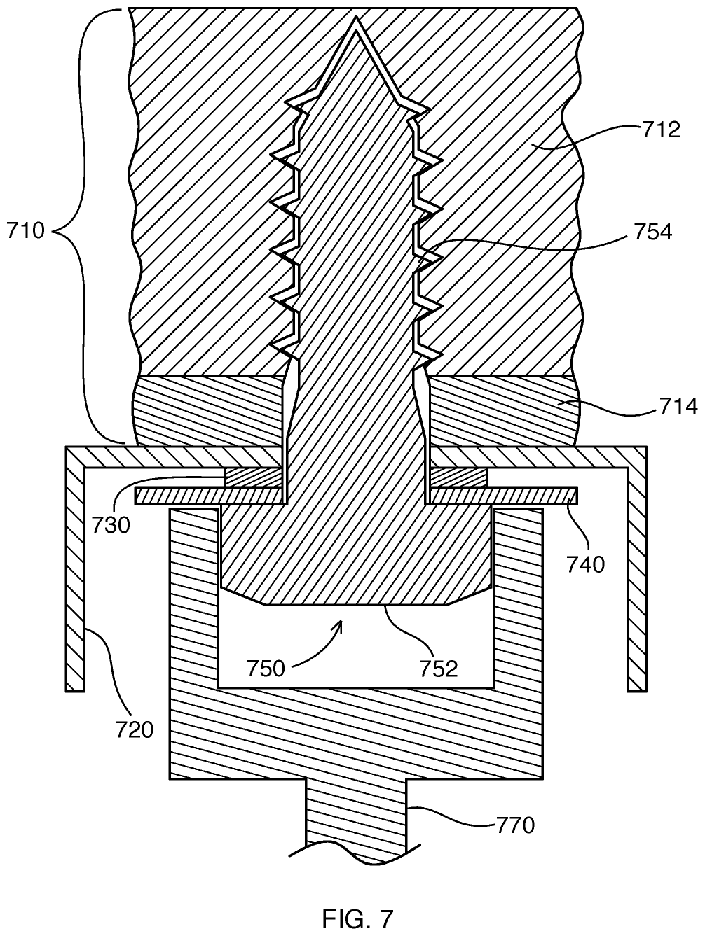

FIG. 7 shows a pre-installed embodiment with the outer diameter of washer 740 being large enough so that as an installer uses tool 770 to drive screw 750 toward structure 710, tool 770 does not obstruct the visual indication from force indicator 730 that the desired clamping force has been achieved. There are many different tools that can be used to drive the screw. In one preferred embodiment, the tool is a socket as may be found with a socket wrench or a socket driver. In alternative embodiments, the tool is a crescent wrench, an adjustable wrench, or screwdriver. Preferably, the elements of the embodiment shown are otherwise similar to their corresponding elements in FIGS. 1, 2, and 3.

In one preferred embodiment, bracket 120 is made from punched and bent steel sheet metal. The cross section (perpendicular to the length) is generally rectangular with one side of the rectangle open. It includes a multitude of mounting holes through which screw 150 can pass to thread into structure 110. These mounting holes are part of a pattern of similar holes spaced along the length of bracket 120. The pattern is designed with more holes than needed, the hole spacing is closer together than needed, thus allowing for variations in support structure design and/or for where more than one screw is used to mount the bracket to the structure. Bracket 120 is configured to support one or more item of utility. More preferably, bracket 120 is configured to support items from the Smarterhome catalog of products, including MyLifter™, Sound Drop, Power Adapter, and Smart Track components. More preferably, bracket 120 is the bracket that is part of the Smart Track system.

Preferably, structure 110 is that of a wall or ceiling in a building. More preferably, structure 110 is that commonly found in residential or light industrial areas such as houses, apartments, garages, shops, sheds, or laboratories.

Structure 110 includes a spanning element 114 that spans a framing structure 112. Spanning element 114 may be selected from a wide variety of materials which can span the distance between the framing structure. Common materials include drywall, sheet metal, corrugated sheet metal, wood (such as plywood, OSB, or particleboard), tile, stone, fiberglass, carbon fiber. Additional materials include paper, foils, plastics, glass, and fabric. Spanning element 114 may or may not include a coating which changes the spanning element's appearance such as paint, stickers, signage, and wallpaper. Additionally, spanning element 114 may be a composite comprising more than one type of material. Such a composite may or may not include a bonding agent adhering the materials of the composite together. Preferably, spanning element 114 is drywall or wood.

In a preferred embodiment, the female threads of structure 110 are integrated into framing structure 112 through creating the threads by removing and/or displacing material in structure 112. In an alternative embodiment, the female threads of structure 110 are created through the use of a nut, such as a standard hexagonal nut or a more specialized nut such as a T-nut or rivet nut. Additionally, an anchor may be installed into structure 112 for the screw to thread into. The use of anchors can facilitate the omission of structure 112 as mentioned below. In another alternative embodiment, the female threads of the structure could be a part of the bracket, thus creating a different order for the elements of the system to be relative to each other and the screw head.

Framing structure 112 may be selected from a wide variety of structural materials that can be designed and/or configured to transfer loads. Common material types are wood, metal, plastic and resin-based products, and other semi-ridged materials. Common wood materials include various lengths of 2×4, 2×6, 4×4, circular/elliptical or other geometric shapes and sizes.

Metal shapes are typically made through one or more of forming, welding, casting, and extruding shapes. Steel and aluminum are some of the most common metals used for structural shapes. Common metal shapes are rod, bar, pipe, rectangular or round tube, I-beam, T-beam, C-channel, and a variety of extruded shapes that facilitate the use of fasteners to attach articles to the structural materials. Plastics and resin-based products can be made in shapes similar to the wood and metal structural shapes and are also made in a variety of additional shapes produced in manufacturing methods which are less common in wood and metal working. Such processes include injection molding, rotational molding, vacuum forming, pressing, and wrapping/winding.

In an alternative embodiment, spanning element 114 may not be included in structure 110. In another alternative embodiment, framing structure 112 may be excluded.

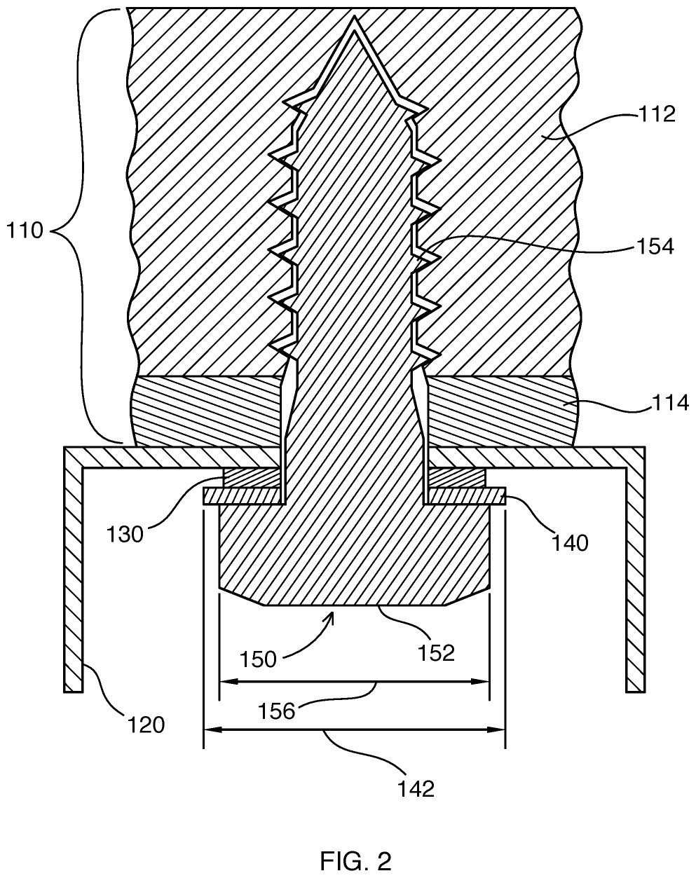

FIG. 2 is a cross sectional representation of the embodiment in FIG. 1 before the force indicator 130 has been deformed by any clamping force created by screw 150 being threaded into structure 110.

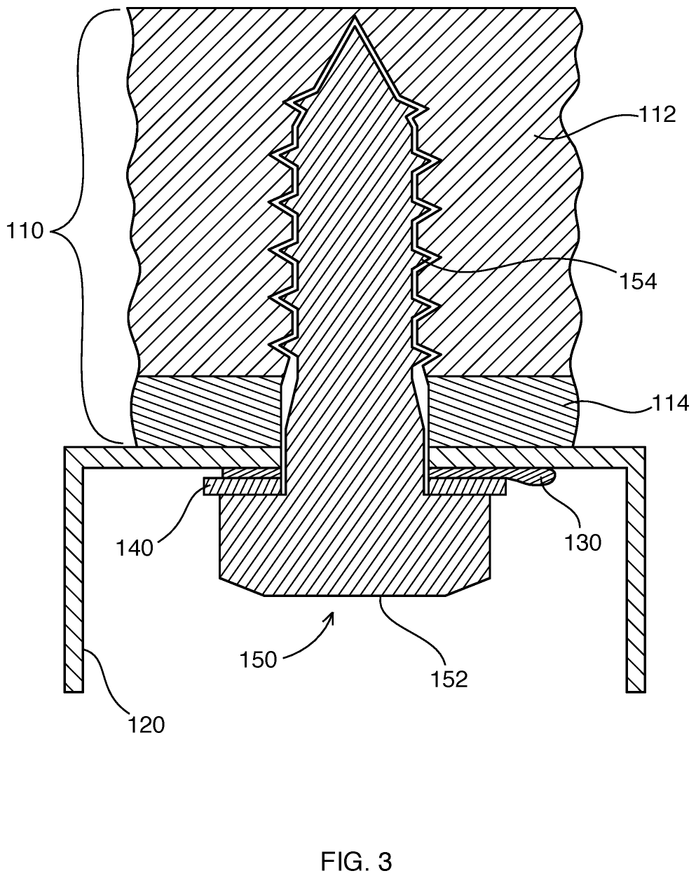

FIG. 3 is a cross sectional representation of the embodiment in FIG. 1 with force indicator 130 having been deformed by the clamping force created by screw 150 being installed into structure 110 and a portion of the force indicator 130 becoming visible to an installer. It should be noted that this figure is not representative of all possible ways the force indicator may deform to become visible. More particularly, due to variables such as material and geometry inconsistencies, it is unlikely that a post-loading force indicator will have a typical geometry in deformation other than when a portion of the force indicator extrudes past the perimeter or diameter of screw 150 or washer 140 becoming visible to an installer. Preferably, the force indicator becomes visible to the installer at or after a desired minimum clamping force has been achieved and before the screw has been overtightened.

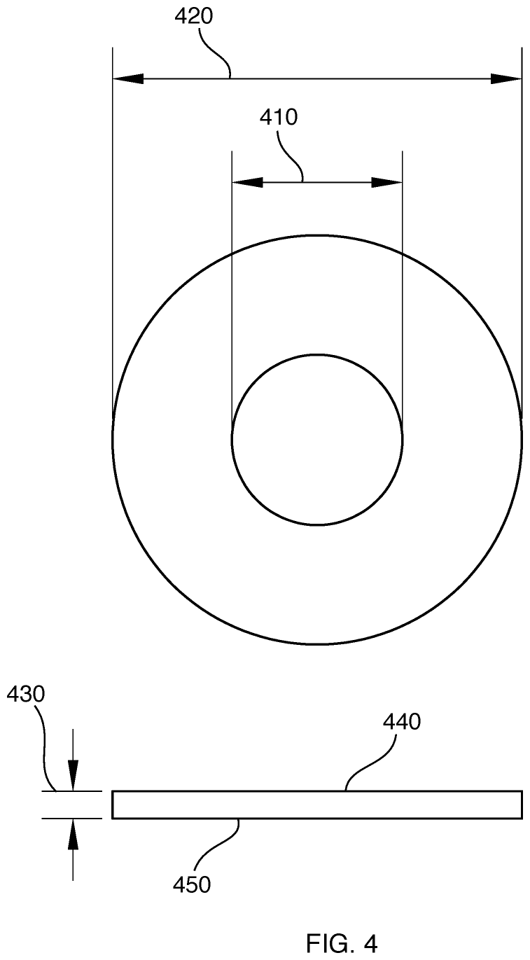

FIG. 4 shows a pre-deformed embodiment of force indicator 130 with various geometrical features referenced as follows: inner diameter (ID) 410, which is the diameter of the hole in the force indicator; outer diameter (OD) 420, which is the diameter of the force indicator; thickness (T) 430, which is the thickness of the force indicator; a surface (A) 440, which is a surface on one side of the force indicator between the ID and OD; and a surface (B) 450, which is a surface on the other side of the force indicator between the ID and OD. Preferably, OD is smaller than the diameter of washer 140 and/or the perimeter of screw head 152. In one preferred embodiment, OD is also small enough that force indicator 130 will not be visible if the hole in force indicator 130 is aligned with screw shank 154 and either surface 440 or surface 450 is flush with screw head 152. Preferably, ID is larger than the diameter of the screw shank 154 and smaller than the diameter of washer 140. Alternatively, ID is also smaller than the perimeter of screw head 152. Alternatively, surface 440 and/or 450 may have protrusions of the same material as the rest of the load indicator.

Preferably, force indicator 130 is designed to deform significantly more than any other component in the mounting system depicted in FIGS. 1, 2, and 3 as the system progresses from FIG. 2 to FIG. 3. Alternatively, there are other design configurations that would also work, such as structure 110 including a compressible layer—like fabric or wallpaper—that can substantially compress before force indicator 130 deforms to become visible. Many factors contribute to the force indicator deforming before the other components, including material selection for each element, contact surface areas between elements, and the number of threads engaged between screw 150 and structure 110. Preferably, screw 150, washer 140, and bracket 120 are metal (such as aluminum, steel, or stainless steel), though they may be a relatively hard material such as plastic or wood. As mentioned above, preferably structure 110 is a composite wherein framing structure 112 is wood and spanning element 114 could be any number of materials.

Preferably, force indicator 130 has a hardness that is lower than the other components in the system. More preferably, force indicator 130 has a measurement on the Shore 00 scale below 100—though given the design choices for other elements of the system, a hardness above that measurable on the Shore 00 scale will work. More preferably, force indicator 130 measures below 80 on the Shore 00 scale. More preferably, the force indicator is rubber.

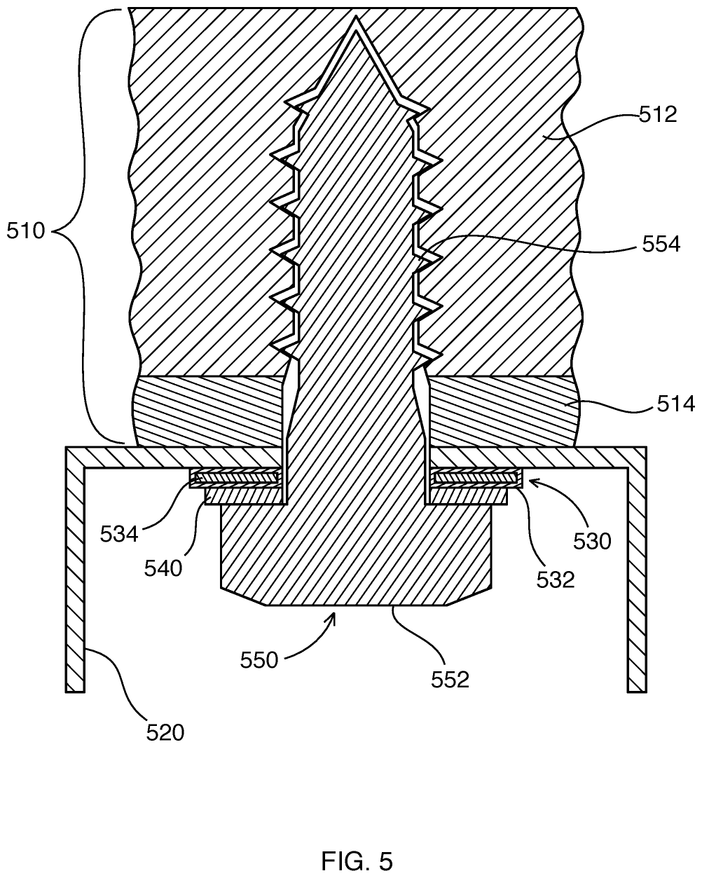

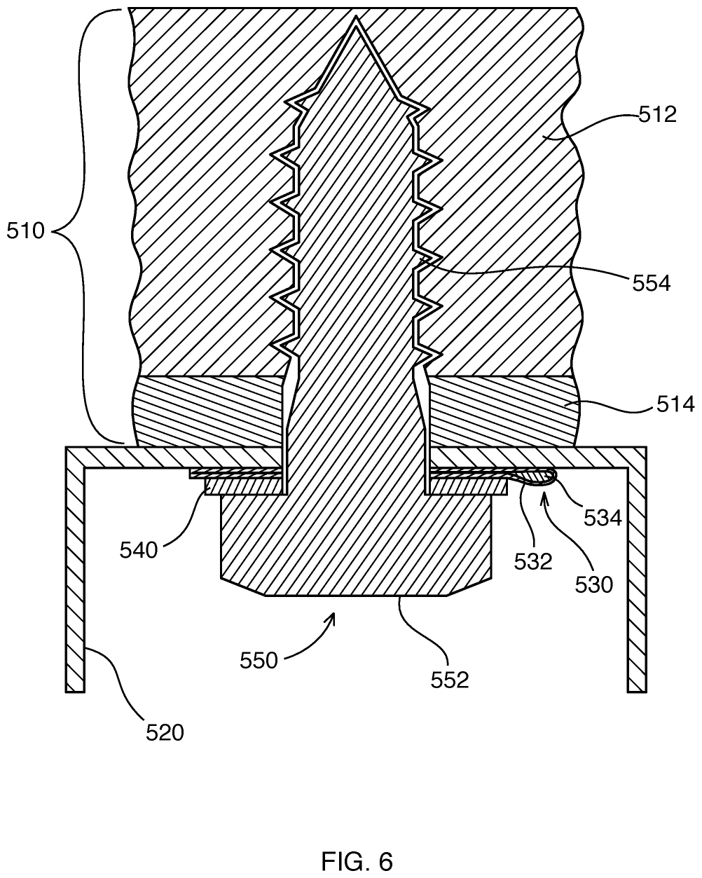

FIGS. 5 and 6 depict an alternative embodiment of the invention wherein force indicator 530 is a composite of outer material 532 and inner material 534. Preferably, when indicating a clamping force, inner material 534 physically adjusts outer material 532. Example types of adjustment an inner material may perform to an outer material include stretching, moving, and/or breaking the outer material. FIG. 5 is a pre-installed state wherein there is no clamping force due to screw 550 being threaded into structure 510.

FIG. 6 is a post-installed state, wherein screw 550 has been threaded into structure 510. Additionally, screw shank 554 has been pretensioned by screw head 552, the mating threads in framing structure 512, and the resistive forces in washer 540, force indicator 530, bracket 520, and spanning element 514. Of particular note, inner material 534 has extruded to the left and caused outer material 532 to thin. Preferably, the result is that outer material 532 is translucent, has thinned, and after thinning allows for better viewing of inner material 532. Preferably the elements in FIGS. 5 and 6 are similar to their corresponding elements in FIGS. 1, 2, and 3, except for force indicator 530.

Preferably, outer material 532 deforms more under stress than any of washer 540, screw 550, and bracket 520 would at the same stress. Preferably, outer material 532 is translucent and becomes more transparent as it stretches and/or thins. Preferably, inner material 534 is or acts like a fluid at forces much lower than the other elements of this system. More preferably, inner material 534 is a non-compressible fluid, is opaque, and is a color that contrasts with outer material 534, washer 540, screw 550, and bracket 520. Alternatively, inner material 532 is neon and/or glow-in-the-dark.

In an alternative embodiment to that depicted in FIGS. 5 & 6, inner material 534 breaks and/or breaches the barrier created by outer material 532 in order to provide visual indication the desired clamping load has been achieved.

In another alternative embodiment to that depicted in FIGS. 5 & 6, the force indicator has an inner diameter that includes the deformable material and an outer diameter which includes the outer material. As the clamping force is applied, the deformable material pushes the outer material radially away from the screw. In another alternative embodiment, the force indicator additionally has an exterior structure housing the deformable material and the outer material. More preferably, this exterior structure includes one or more viewing windows that initially display the outer material and, as the clamping force is applied, the deformable material becomes visible through the viewing windows. The structure may or may not be configured to improve the structural characteristics of a pretensioned connection. Alternatively, the outer material is not initially viewable through the viewing windows and the deformable material becomes visible as the clamping force is applied.

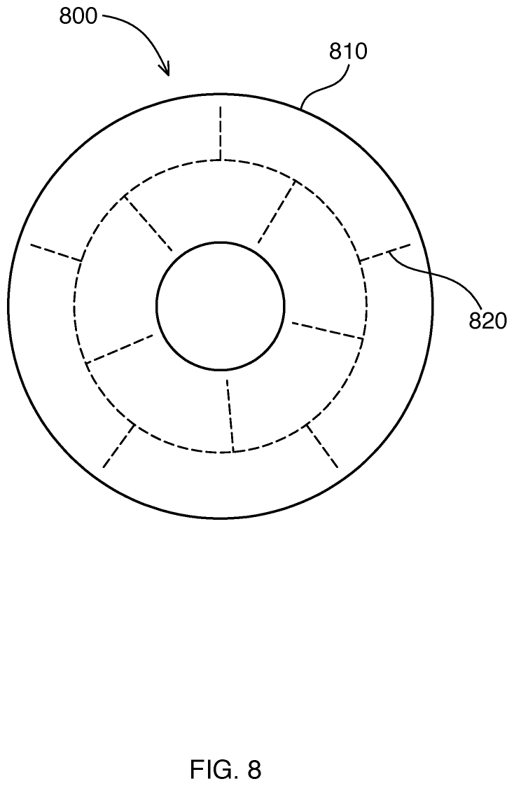

FIG. 8 depicts another alternative embodiment. Here, force indicator 800 includes structural element 820 as an internal skeleton to deforming material 810. In this embodiment, as an installer drives the screw into the structure, deforming material 810 extrudes outward to provide a visual indication that the desired clamping force has been achieved. Deforming material 810 is similar to the material in force indicator 130. Internal skeleton 820 is less fluid than deforming material 810 under load. Preferably internal skeleton 820 is more ridged than deforming material 810. More preferably, it is plastic or metal.

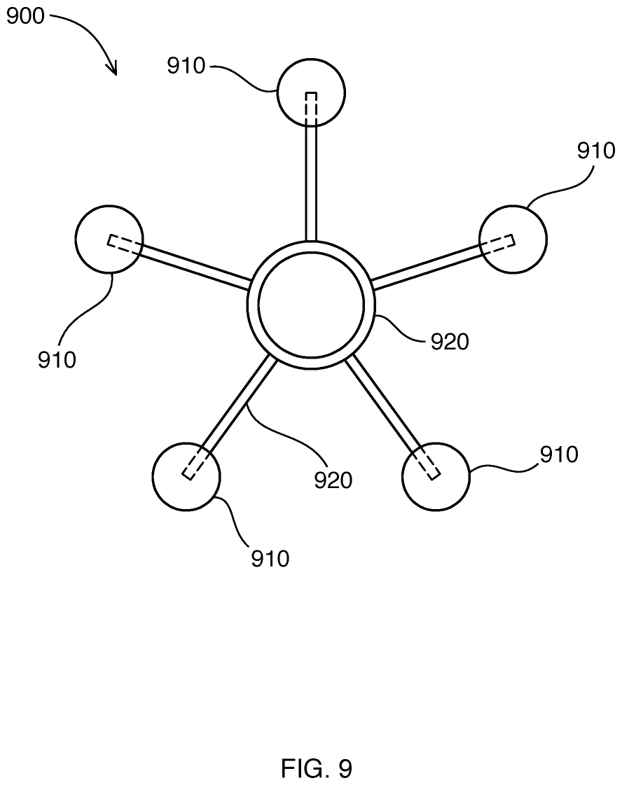

FIG. 9 depicts another alternative embodiment. Here, force indicator 900 includes structural element 920 as an external skeleton for deforming material 910. In this embodiment, as an installer drives the screw into the structure, deforming material 910 extrudes outward to provide a visual indication that the desired clamping force has been achieved. Deforming material 910 is similar to the material in force indicator 130. External skeleton 920 is less fluid than deforming material 910 under load. Preferably external skeleton 920 is more ridged than deforming material 910. More preferably, it is plastic or metal.

In another alternative embodiment, the load indicator includes a material in addition to the deformable material which obscures the deformable material. Upon being clamped by the clamping force, the deformable material modifies the obscuring material, thus providing a visual indication of the requisite clamping force.

Alternatively, one embodiment of the invention requires the breaking of a boundary between chemicals which chemicals react to create a visible indication to an installer that the desired force has been achieved. One example of this is baking soda and vinegar. Another example is that of a chemical that reacts with air. The selection of these chemicals depends on various criteria, such as how the chemicals will affect the other elements of the system, potential cleanup, visibility to an installer, and toxicity to an installer.

In another alternative embodiment, the force indicator contains one or more chamber that, when breached due to the minimum design clamping force, excretes the contents of the chamber, thus allowing the contents to become visible by an installer.

One method for determining the force at which the force indicator will become visible is through testing, such as using a known compression force or known torque to flatten the force indicator. Through this means, the force indicator can be designed to indicate the desired minimum clamping force.

Another method for determining the force at which the force indicator will become visible is through engineering calculations. One way these calculations may be performed includes using the compressive strength of the material in combination with the area of surfaces A and B being compressed to calculate the force required to deform the force indicator and using the thickness T to determine if there is enough material in the force indicator to become visible when the force indicator is deformed.

One preferred method of fabricating the force indicator is injection molding. An alternative method is cutting it from a sheet of the desired thickness using a die, rolling die, or CNC cutting machine. Another alternative is extruding and cutting the material to the desired shape and thickness. In general, these methods could be used to produce a single force indicator, though the preferred method would likely be a version that has been scaled up for mass production and optimizes (1) reliability, (2) production over a set period of time, (3) cost, and (4) other relevant business and engineering factors.

Preferably, the force indicator will be easy to see, especially when the force indicator is in a state which indicates the desired clamping force has been achieved. Preferably, this visibility is achieved through the selection of the material color. More preferably, the selection will be from colors that have a high contrast compared to metals in direct or indirect indoor lighting, such as neon colors or safety colors. Still more preferably, the force indicator will visibly contrast with bracket 120, screw 150, and washer 140.

Alternatively, the force indicator could be luminescent. Such a feature could facilitate visibility in low-light setting. In one embodiment, the luminescence is achieved by manufacturing the force indicator from material that is glow-in-the-dark or photoluminesces. More preferably, a glow-in-the-dark force indicator would also be of a high contrast color as described in the above paragraph.

The invention has been described with reference to various specific and preferred embodiments and techniques. Nevertheless, it is understood that many variations and modifications may be made while remaining within the spirit and scope of the invention.

What is claimed is:

1. A system for mounting to a structure, comprising:
a screw comprising a screw head;
a bracket; and
a force indicator positioned between the screw head and the bracket, the force indicator comprising a deformable material;
wherein, as an installer drives the screw head toward the structure, the deformable material is compressed between the screw head and the bracket to the point that at least a portion of the deformable material is extruded radially so as to provide a visual indication that the screw has achieved a sufficient clamping force to secure the bracket to the structure without overtightening.

2. The invention of claim 1, wherein the screw threads into a wooden portion of the structure.

3. The invention of claim 1, wherein the structure is a ceiling in a garage.

4. The invention of claim 1, wherein the force indicator is of a color to visually contrast with that of the screw and/or bracket.

5. The invention of claim 1, wherein the force indicator is safety colored.

6. The invention of claim 1, wherein the force indicator is glow-in-the-dark.

7. The invention of claim 1, wherein the force indicator comprises a second material, said second material obscuring said deformable material, and wherein, as the installer drives the screw head toward the structure, the deformable material physically adjusts the second material.

8. The invention of claim 1, wherein the screw head comprises a perimeter, the force indicator comprises an outer diameter, and the outer diameter is initially smaller than the perimeter, and wherein as the installer drives the screw head toward the structure, the deformable material extrudes beyond the perimeter of the screw head.

9. The invention of claim 1, wherein the mounting system also comprises a washer positioned around the screw shank, abutting the force indicator, and between the screw head and the bracket.

10. The invention of claim 9, wherein the washer comprises a perimeter, the force indicator comprises an outer diameter, and the outer diameter is initially smaller than the perimeter, and wherein, as the installer drives the screw head toward the structure, the deformable material extrudes beyond the perimeter of the screw head.

11. The invention of claim 10, wherein the perimeter of the washer is larger than the diameter of a tool with which the installer drives the screw.

12. The invention of claim 1, wherein the force indicator is disc shaped with a hole for the screw shank.

13. The invention of claim 12, wherein the force indicator further comprises one or more protrusions.

14. The invention of claim 1, wherein the deformable material comprises a polymer.

15. The invention of claim 1, wherein the deformable material plastically deforms as a result of the compression.

16. The invention of claim 1, wherein the deformable material elastically deforms as a result of the compression.

17. The invention of claim 1, wherein the force indicator further comprises a structural skeleton to hold the deformable material prior to the deformable material being compressed.

18. A system for mounting to a structure, comprising:
a screw comprising a screw head;
a washer, the washer having a perimeter;
a bracket; and
a force indicator positioned between the washer and the bracket, the force indicator comprising a deformable polymer material, a 2-dimensional cross section with concentric inner and outer diameters, and a thickness;
wherein, as an installer drives the screw head toward the structure, the deformable material is compressed between the washer and the bracket to the point that at least a portion of the deformable material is extruded radially past the washer perimeter so as to provide a visual indication that the screw has achieved a sufficient clamping force to secure the bracket to the structure without overtightening.

19. A method for installing a bracket to a structure, comprising the steps of:
providing a screw comprising a screw head;
providing a bracket; and
providing a force indicator positioned between the screw head and the bracket, the force indicator comprising a deformable material;
driving the screw through a force indicator and bracket to secure the bracket to a structure;
while driving the screw, watching for a visual indication from the force indicator that the screw has achieved a sufficient clamping force to secure the bracket to the structure; and
after observing the visual indication from the force indicator that the screw has achieved a sufficient clamping force to secure the bracket to the structure, stopping the driving of the screw before overtightening.

20. The method of claim 19, wherein the deformable material is plastically deformable.
